(19) United States
(12) Patent Application Publication
(10) Pub. No.: US 2008/0060500 A1
(43) Pub. Date: Mar. 13, 2008

(54) Electronic musical page turner

(76) Inventors: Ton La, Houston, TX (US); Ton La, Houston, TX (US)

Correspondence Address: TON LA, 4418 WARM SPRINGS RD., HOUSTON, TX, 77035, US

(21) Appl. No.: 11/517,003

(22) Filed: Sep. 7, 2006

(51) Int. Cl. G10G 7/00

(52) U.S. Cl. 84/486

(57) ABSTRACT

An electronic musical page turner is consisted of a LCD (liquid crystal display) display, triple foot actuator switches, and an external personal computer, scanner, USB portable storage device, and USB wireless electronic pen.

The system transfers and displays of electronic score music files using many available software and electronic music files format such as PDF, Scorches, Solora, etc . . . The musical score data can be exchanged between the LCD display and a personal computer through the use of foot actuators and command functions on LCD display's control menu. The LCD can display two pages of music score in landscape viewing mode or one page in portrait viewing mode. Foot actuators are manipulated by the performer to progress the sheet music score on the LCD display. The performer can turn the electronic sheet music score to next page, previous page, or home page by pressing specific foot actuator. Likewise, the performer can edit or add hand written notation onto electronic sheet music score by using USB wireless electronic pen, and scan personalized hard copy sheet music score into electronic file.

### BACKGROUND OF THE INVENTION

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

1. Field of the Invention

The present invention relates to an electronic musical page turner particularly pertain to turn sheet music score without using hand intervention. This electronic musical page turner can be used to display all type of electronic sheet music files available on variety formats. Turning electronic sheet music on LCD display can be done by using foot actuators. Thus, musician can practice or perform more effectively.

Normally, printed sheet music score is required when student or musician practices, recitals, or performs, momentary freeing one hand from playing music score to turn sheet music is very distracts and disturbs.

Frequently musician required printed sheet music score during the performance, musician such as pianist needs page turner who must turn sheet music score at precise time, music sheet may be turned too early or too late, page tuner's hand blocks musician's view, ruffling noise creates from turning sheet music are annoying to the musician and audiences as well.

Furthermore, when student or musician practices in an inadequate lighting condition, printed sheet music score may not be comprehended accurately, as a result off-tone note might be played.

Printed sheet music also has other problems, such as loosing page, crumbling and fading, or falling off from music stand.

Several computer software have been developed for displaying and editing electronic sheet music score. These systems include the SOLERO Music Viewer software from Sunhawk Corporation of Seattle; Scorch Music Viewer and Silbelius Music Viewer and Editor software from Silbelius Software, Ltd. of the United Kingdom; Music WRITER Plus music viewer and editor software from Voyetra Technologies Inc. of New York; FINALE SongWriter music viewer and editor software from Coda Music Technology Inc. of Minnesota; Smartscore music scanning and notation software from Musitek Corporation of Ojai, Calif.; PowerPoint presentation (allows sheet music score to be viewed and edited using scan PDF file, also known as Adobe Acrobat file) from Microsoft Corporation, Redmond, Wash. These computer software and systems allow electronic music score to be displayed, edited, and scanned using the present invention.

2. Description of Related Art

Known prior art includes U.S. Pat. No. D428,044; U.S. Pat. No. 5,233,900; U.S. Pat. No. 5,052,266; U.S. Pat. No. 6,051,769; U.S. Pat. No. D448,401.

The electronic musical page turner according to the present invention departs from the concepts and designs of the prior art, provides an equipment developed primarily for the purpose of allowing performer to turn sheet music score without the need for hand intervention and the need for person to turn sheet music manually, permitting performer to scan personalized hard copy sheet music score into electronic file, and allowing performer to edit or add hand written notation onto electronic sheet music score using USB wireless electronic pen.

### SUMMARY OF THE INVENTION

An electronic musical page turner turns electronic sheet music score efficiently and effortlessly by using foot actuator, which is operated by the performer, during practices or performs without using hand to turn hard copy sheet music.

It is objective of the present invention to allow musician to display music score electronically onto LCD display using illuminated LCD display technology.

It is another object of the present invention to allow musician to play hands free and be able to turn sheet music score electronically to next page, previous page, or back to home page without hands intervention.

It is another objective of the present invention to allow musician to scan personalized hard copy music score into electronic file, store in hard disk drive or USB portable storage device and display on LCD display.

It is another objective of the present invention to allow musician to use USB wireless electronic pen to edit or add hand written notation onto electronic sheet music score and save it for future reference.

It is another objective of the present invention to allow musician to organize, personalize, and store music manuscripts to score list file manager in personal computer or USB portable storage device, which can be readily accessed.

It is another objective of the present invention to allow musician to upload electronic music score file from personal computer and USB portable storage device to LCD display.

These objectives will be clear from the following brief and detailed of the description of the invention.

### BRIEF DESCRIPTION OF THE DRAWINGS

The drawings illustrated in the invention are presently preferred, however the invention is not limited to the precise arrangement as shown in the drawings.

FIG. 1 is a front face of the electronic musical page turner LCD display shown on portrait view in accordance with the inventive disclosures herein.

FIG. 2 is a front face landscape isometric view of the electronic musical page turner LCD display.

FIG. 3 is a front face portrait isometric view of the electronic musical page turner LCD display.

FIG. 4 is a schematic diagram of various hardware components of the present invention.

FIG. 5 is a top view of the triple foot actuator switches.

FIG. 6 is a block diagram of the personal computer.

### DETAILED DESCRIPTION OF THE PREFERRED EMBODIMENTS

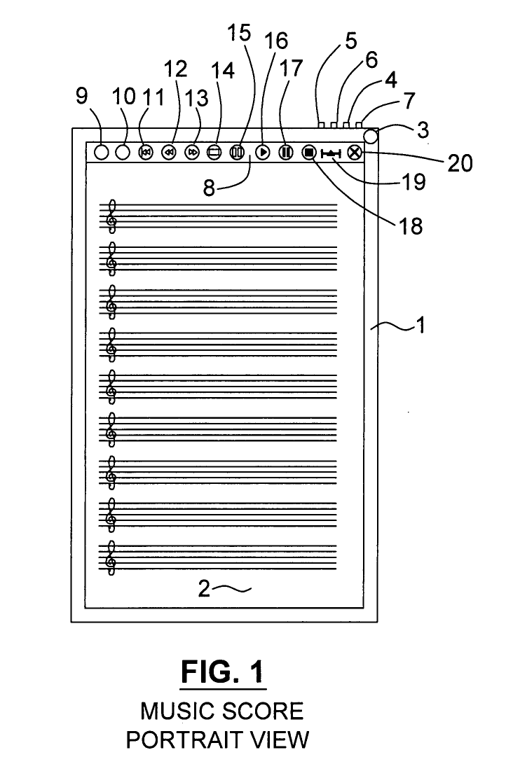

FIG. 1 is a LCD display of the electronic musical page turner shown in portrait view. The frame 1, houses and keeps the LCD display in place; The LCD display screen 2, is a liquid crystal display which is suitable for displaying in low lighting condition. The LCD display comprises of an anti-glare coating to minimize glare and reflective to improve clarity and contrast for better viewing music score. The On-Off illuminated push-button 3, is used to turn the LCD display on or off. When the On-Off button is not lit, the LCD display is off. However, with the On-Off illuminated, the LCD display is on. Contrast and brightness of the LCD display is controlled by: menu selector button 4, selection for contrast and brightness; adjustment buttons 5 & 6, adjust up and down for contrast and brightness; menu on-off button 7, turn on or off the LCD display onscreen display control menu. Onscreen display's icons menu bar 8, is for opening and manipulating an electronic sheet music score using USB wireless electronic pen. Its comprises of:

Score list icon 9, opening a sheet music score from score list;

Open a score icon 10, opening a sheet music score from personal computer's hard disk drive, USB portable storage drive, or CD drive Home Page icon 11, turn sheet music score back to home (first) page;

Previous Page icon 12, turn sheet music score to previous page;

Next Page icon 13, turn sheet music score to next page;

Zoom selection 14, choose to display sheet music score in: whole page, width, or percent as desired.

One/Two page icon 15, choose to display one or two sheets music score;

Play icon 16, choose to play with audio music score;

Pause icon 17, choose to pause playing music score;

Stop icon 18, choose to stop playing music score;

Metronome adjustment bar 19, choose to play music score with desire metronome;

Closing an electronic sheet music score is accomplished by activating a close caption icon 20.

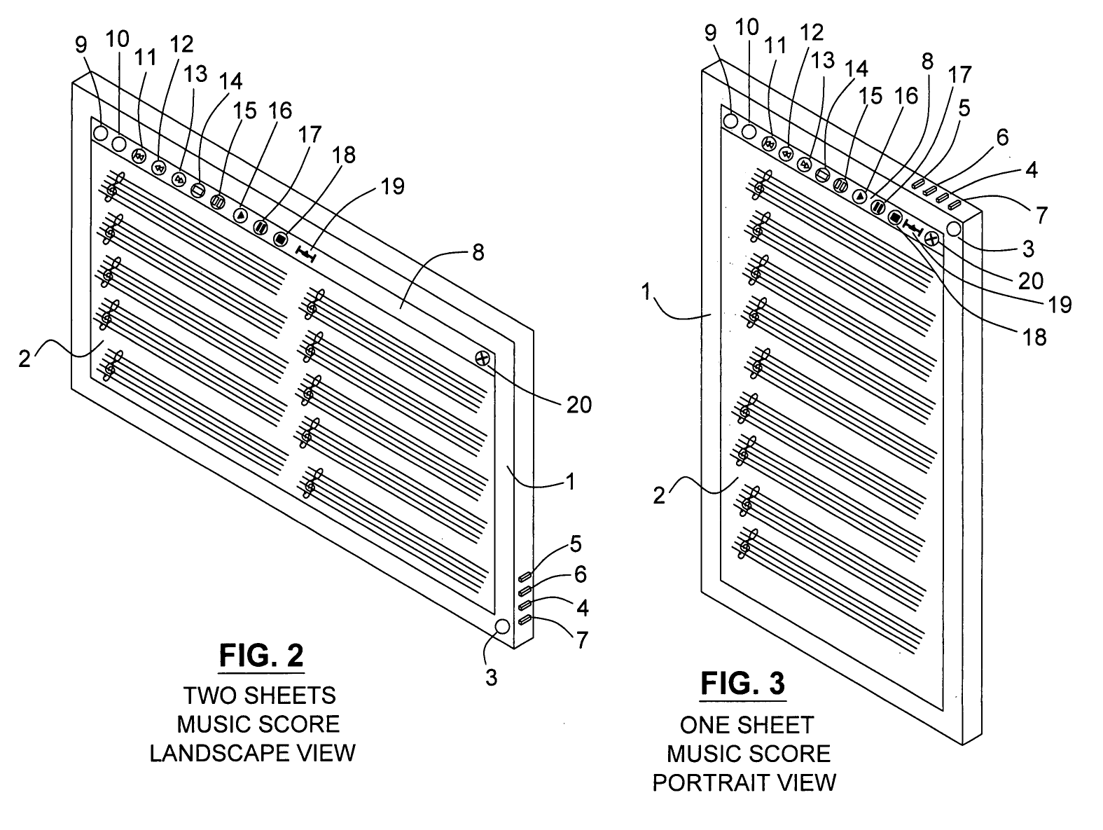

FIG. 2 shows a front face landscape isometric view of the electronic musical page turner LCD display, displaying two sheets of music score. Performer can displayed two sheets of music score by: a) rotating LCD display to landscape view (if LCD display is in portrait view); b) opening a electronic music score file 9, 10; c) activating one/two page icon 15; d) adjusting prefer display for music score using zoom selection 14.

FIG. 3 shows a front face portrait isometric view of the electronic musical page turner LCD display, displaying one sheet of music score. Performer can displayed one sheet of music score by: a) rotating LCD display to portrait view (if LCD display is in landscape view); b) opening a electronic music score file 9, 10; c) activating one/two page icon 15, d) adjusting prefer display for music score using zoom selection 14.

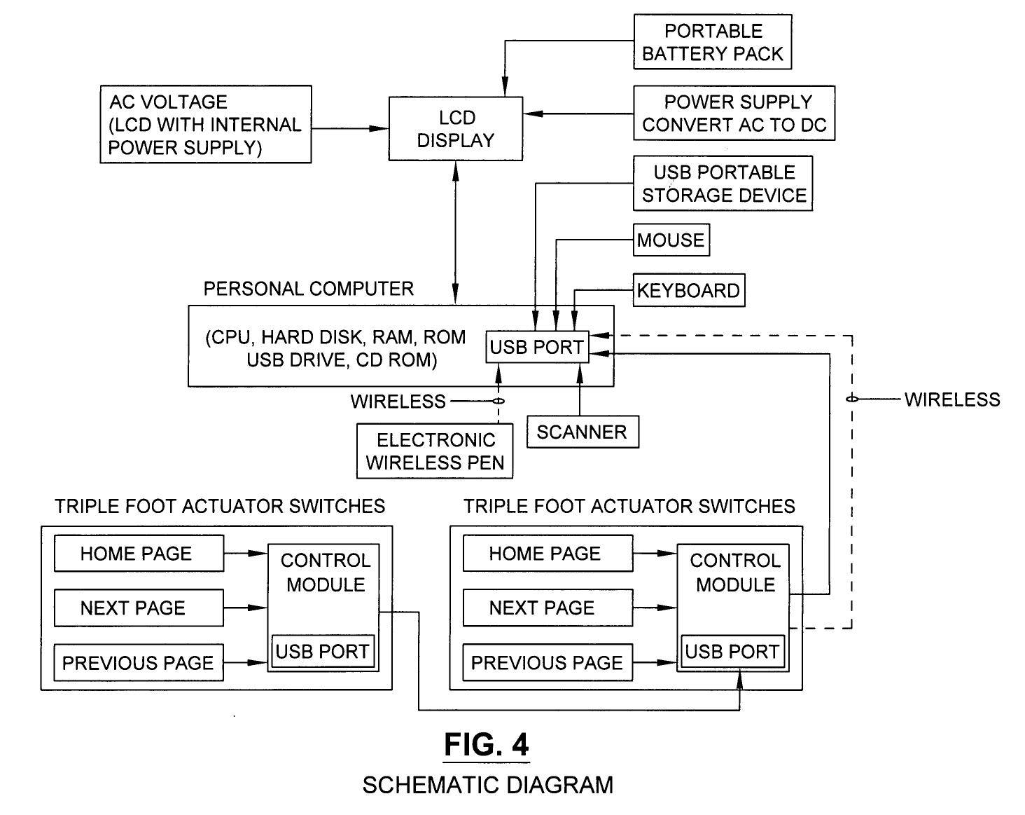

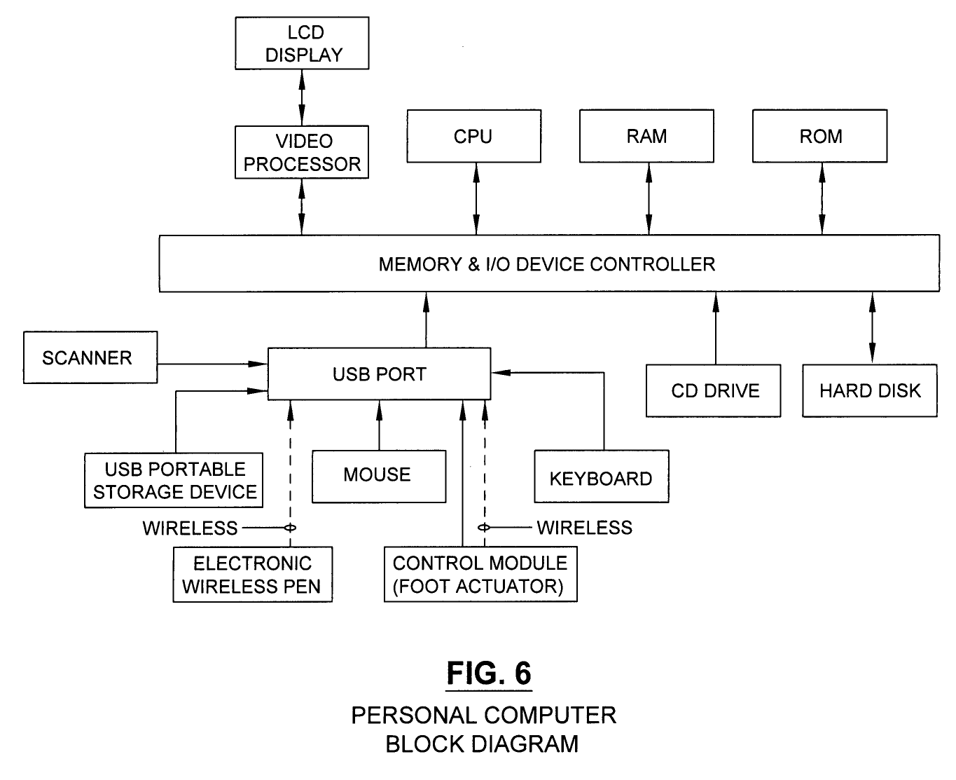

FIG. 4 shows a schematic diagram of various hardware components of the electronic musical page turner according to the preferred embodiment. In the diagram, the foot actuator sends a page turning command to the control module which in turn transmits the command signal to the personal computer through the USB (universal serial bus) cable 28, or USB wireless communication link 29, interface that connect to personal computer's USB port. The command signal is being process on the personal computer's memory & I/O device controller (FIG. 6) which sends and receives information from CPU (central processor unit) to obtain information and temporary store in RAM (random access memory), then implement page turning which display on the LCD display over the video cable. In conclusion, actuate the home page, next page, or previous page foot switches will cause the LCD screen to display the music score to the performer desires. The LCD display can be powered by one of the three methods: 1. receives AC voltage from convenient outlet (LCD has internal power supply that convert voltage from AC to DC); 2. receives DC voltage from external power supply (convert voltage from AC to DC); 3 receives DC voltage from external portable battery pack. Personalized hard copy music score can be scanned using scanner which is connected to USB port. Hand written notation can be edited or added onto electronic sheet music score by using USB wireless electronic pen.

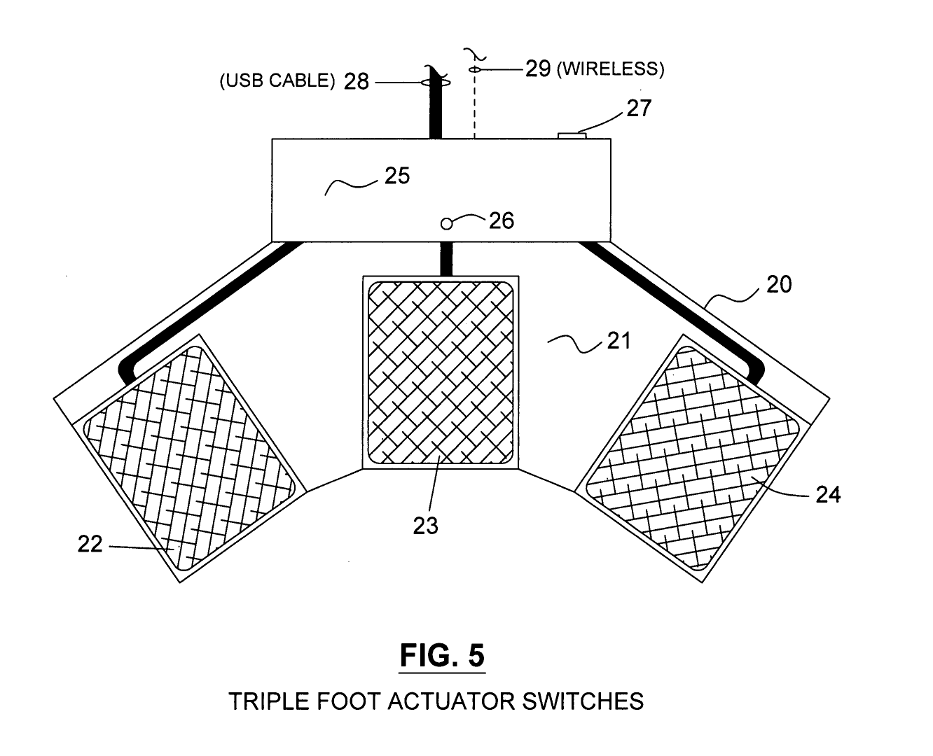

FIG. 5 depicts a triple foot actuator switches 20, which is mounted on the non-skid baseplate 21; the Home Page foot actuator 22, mounts on the far left side of the baseplate; the Next Page foot actuator 23, mounts on the center of the baseplate; the Previous Page foot actuator 24, mounts on the far right side of the baseplate; all three foot actuator switches' contacts are wired to the control module 25; status LED (light-emitting diode) 26, LED on indicates the control module is function; a USB connector 27, allows linking to other triple foot actuators; the control module's USB cable 28, is connected to the USB port at the personal computer. (USB wireless communication link 29, sending control module's command to personal computer, an alternate embodiment to USB cable 28)

FIG. 6 shows personal computer's block architecture functionality. USB port is the signal input and output gateway for control module's foot actuator, keyboard, mouse, scanner, USB removable storage devices, and USB electronic wireless pen. Memory & I/O device controller is the main communication bus for all components shown on the FIG. 6 CPU, RAM, ROM, CD DRIVE, HARD DISK DRIVE, USB PORT, and video processor (LCD display).

What is claimed is:

1. The electronic musical page turner comprising: a LCD (liquid crystal display) display means for displaying sheet music score; analog (VGA) or digital (DVI) video cable means for transferring music score electronic data to LCD display from personal computer; scanner means for scanning personalized hard copy sheet music score into electronic file; USB wireless electronic pen means for editing or adding hand written notation onto electronic sheet music; triple foot actuator switches means for turning electronic sheet music score to next page, previous page, or home (first) page; personal computer, include: laptop, desktop, and tablet notebook, means for storing electronic music sheet files and processing page turning command signals from external triple foot actuator or command functions on the LCD display's control menu icons.

2. The electronic musical page turner of claim 1, wherein the personal computer comprises a music score file manager means implemented through the analog (VGA) or digital (DVI) video cable connection to the LCD display.

3. The electronic musical page turner of claim 2, wherein the personal computer stored electronic sheet music score in the score list file manager or USB portable storage drive.

4. The electronic musical page turner of claim 2, wherein an open function means: opening an electronic sheet music score from personal computer or USB portable storage drive to the LCD display over the analog (VGA) or digital (DVI) video cable connection.

5. The electronic musical page turner of claim 2, wherein a close function means: closing an electronic sheet music score from the LCD display.

6. The electronic musical page turner of claim 2, wherein a delete function means: deleting an electronic sheet music score file from the score list file manager or USB portable storage drive.

7. The electronic musical page turner of claim 2, wherein an add function means: adding an electronic sheet music score file to the score list file manager or USB portable storage drive.

8. The electronic musical page turner of claim 1, wherein the display is a LCD, liquid crystal display, which has high contrast, deep colors and is well-suited for indoor environments and low-light circumstances. The LCD display further comprising: an anti-glare layer on outer surface of the LCD display to reduce glare and improve music score readability.

9. The electronic musical page turner of claim 1, wherein the display is a touch screen LCD display, receive input and command by touching certain parts of the screen, an alternate embodiment to the musical page turner of claim 8.

10. The electronic musical page turner of claim 1, wherein the display is a projector or a large LCD screen for large group of performers such as orchestra or chamber of music, an alternate embodiment to the musical page turner of claim 8.

11. The electronic musical page turner of claim 8, further include a display control menu icons 8, which comprises:
Score list icon 9 means, opening a sheet music score from score list;
Open a score icon 10 means, opening a sheet music score from personal computer's hard disk drive, USB portable storage device, CD drive;
Home Page icon 11 means, turn sheet music score back to home (first) page;
Previous Page icon 12 means, turn sheet music score to previous page;
Next Page icon 13 means, turn sheet music score to next page;
Zoom selection 14 means, choose to display sheet music score in: whole page, width, or percent as desired.
One/Two page icon 15 means, choose to display one or two sheets music score;
Play icon 16 means, choose to play music score with audio, highlight note as it plays, and automatically turns sheet music at the end of music score;
Pause icon 17means, choose to pause playing music score;
Stop icon 18 means, choose to stop playing music score;
Metronome adjustment bar 19 means, choose to play music score with desire metronome;
Close caption icon 20 means, choose to close display of music score on the LCD display.

12. The electronic musical page turner of claim 8, wherein the LCD display displays two sheets music score on landscape view; displays one sheet music score on portrait view.

13. The electronic musical page turner of claim 8, wherein the LCD display receives 120 VAC power from convenient outlet. The LCD display also comprises an internal power supply to convert AC (alternating current) voltage to DC (direct current) voltage.

14. The electronic musical page turner of claim 8, wherein the LCD display receives DC (direct current) voltage from external power supply (LCD display has no internal power supply), alternate embodiment to the musical page turner of claim 13.

15. The electronic musical page turner of claim 8, wherein the LCD display receives DC (direct current) voltage from external portable battery pack (LCD display has no internal power supply), another alternate Embodiment to the musical page turner of claim 13.

16. The electronic musical page turner of claim 8, wherein the LCD display also comprises an illuminated On-Off button 3, on front of LCD display; dimming and brighten control from onscreen display control 4,5,6, and 7.

17. The electronic musical page turner of claim 1, wherein the triple foot actuators 20, comprise three individual foot actuators: Next Page actuator 23, Previous Page actuator 24, Home Page actuator 22, and status LED (light-emitting diode) 26, mounted on a non-skid baseplate 21.

18. The electronic musical page turner of claim 17, wherein the triple foot actuators further comprise a control module 25, for receiving command from foot actuators, 22, 23, and 24.

19. The electronic musical page turner of claim 18, wherein the control module comprise a USB cable 28, for connecting and sending command from control module to personal computer.

20. The electronic musical page turner of claim 18, wherein the control module further comprise a wireless communication link 29, sending control module's command to personal computer, alternate embodiment to the musical page turner of claim 19.

21. The electronic musical page turner of claim 18, wherein the control module further comprise a USB connector 27, on the control module for linking other triple foot actuators.

22. The electronic musical page turner of claim 17, wherein the triple foot actuators configure in ergonomic design.

23. The electronic musical page turner of claim 17, wherein the triple foot actuators comprise quiet actuator switches.

24. The electronic musical page turner of claim 17, wherein actuates Next Page foot actuator turns the music score to next page.

25. The electronic musical page turner of claim 17, wherein actuates Previous Page foot actuator turns the music score to previous page.

26. The electronic musical page turner of claim 17, wherein actuates Home Page foot actuator turns the music score to home (first) page.
